(19) United States
(12) Patent Application Publication
(10) Pub. No.: US 2025/0063490 A1
(43) Pub. Date: Feb. 20, 2025

(54) RELAY OPERATIONS FOR WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/793,393

(22) Filed: Aug. 2, 2024

Related U.S. Application Data
(60) Provisional application No. 63/519,886, filed on Aug. 16, 2023.

(51) Int. Cl. H04W 48/20; H04L 5/00; H04W 72/0453

(52) U.S. Cl. CPC H04W 48/20; H04L 5/0055; H04W 72/0453

(57) ABSTRACT

Disclosed herein is a method performed by a relay station (STA). The method includes receiving an association request frame for associating with the access point (AP) from the non-relay STA, relaying the association request frame from the non-relay STA to the AP, receiving an association response frame from the AP, relaying the association response frame from the AP to the non-relay STA, receiving a data frame from the non-relay STA, wherein the data frame includes data originated by the non-relay STA that is intended for the AP, transmitting an acknowledgement (ACK) frame to the non-relay STA, wherein a source address of the ACK frame is an address of the AP, and relaying the data originated by the non-relay STA from the non-relay STA to the AP.

### CROSS-REFERENCE TO RELATED APPLICATION

This application claims the benefit of U.S. Provisional Application No. 63/519,886 filed Aug. 16, 2023, which is hereby incorporated by reference.

### TECHNICAL FIELD

The present disclosure generally relates to wireless communications, and more specifically, relates to relay operations in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Some of the objectives of the next generation of wireless networking standards (e.g., IEEE 802.11bn or beyond IEEE 802.11be) include improving the data rate and range of communications. However, improving data rate and improving communication range are often competing objectives (there is a tradeoff between data rate and communication range).

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a network environment in which relay operations may be performed, according to some embodiments.

FIG. 11 is a diagram showing relay operations using an implicit relay approach, according to some embodiments.

FIG. 12 is a diagram showing relay operations using an explicit relay approach, according to some embodiments.

FIG. 13 is a diagram showing a MU frame format that can include relayed data and data originated by the relay STA

FIG. 14 is a flow diagram of a method for communicating with an AP with the aid of relay operations (using an implicit relay approach), in accordance with some embodiments of the present disclosure.

FIG. 15 is a flow diagram of a method for performing relay operations (using an implicit relay approach), in accordance with some embodiments of the present disclosure.

FIG. 16 is a flow diagram of a method for communicating with a non-relay STA with the aid of relay operations, in accordance with some embodiments of the present disclosure.

FIG. 17 is a flow diagram of a method for communicating with an AP with the aid of relay operations (using an explicit relay approach), in accordance with some embodiments of the present disclosure.

FIG. 18 is a flow diagram of a method for performing relay operations (using an explicit relay approach), in accordance with some embodiments of the present disclosure.

### DETAILED DESCRIPTION

The present disclosure generally relates to wireless communications, and more specifically, relates to relay operations in a wireless network.

As mentioned above, some of the objectives of the next generation of wireless networking standards (e.g., IEEE 802.11bn or beyond IEEE 802.11be) include improving data rate and communication range. However, improving data rate and improving communication range are often competing objectives (there is a tradeoff between data rate and communication range). Relay operations and frame structures are described herein that can be used to extend communication range in a wireless network without having to significantly sacrifice data rate.

The present disclosure describes two types of relay operations: (1) an implicit relay approach and (2) an explicit relay approach. In the implicit relay approach, STAs that have the capability to act as a relay STA (which may be referred to herein as potential relay STAs) recognize the need for relay operations and act as a relay between a non-relay STA and an AP. However, the relay operations are transparent to the non-relay STA. That is, the non-relay STA does not know that its communications with the AP are being relayed by a relay STA. In contrast, in the explicit relay approach, the non-relay STA is aware that its communications with the AP are being relayed by a relay STA.

A relay STA may act as a relay between a non-relay STA and an AP to extend the communication range therebetween. It should be appreciated that a particular STA can be a relay STA in some circumstances and be a non-relay STA in other circumstances.

With the implicit relay approach, the non-relay STA may transmit an association request frame for associating with the AP. The relay STA may relay the association request frame from the non-relay STA to the AP responsive to detecting that the non-relay STA has transmitted a plurality of association request frames for associating with the AP to the AP without the AP transmitting a corresponding association response frame to the non-relay STA. Responsive to receiving the association request frame that was relayed by the relay STA from the non-relay STA to the AP, the AP may transmit an association response frame. The relay STA may relay the association response frame from the AP to the non-relay STA. The exchange of the association request frame and the association response frame between the non-relay STA and the AP (via the relay STA) completes the association between the non-relay STA and the AP. The non-relay STA may then transmit a data frame that includes data intended for the AP. Responsive to receiving the data frame, the relay STA may transmit an acknowledgement (ACK) frame to the non-relay STA. Even though the relay STA transmits the ACK frame, the source address of the ACK frame may be set to be the address of the AP to make it seem like the ACK frame is coming from the AP. The relay STA may then relay the data from the non-relay STA to the AP. In an embodiment, the relay STA relays the data to the AP by transmitting a multi-user (MU) frame that includes the data (that was originated by the non-relay STA) and data originated by the relay STA that is intended for the AP. Responsive to receiving the MU frame, the AP may transmit a MU ACK frame to the relay STA that acknowledges that the AP received the relayed data and the data originated by the relay STA.

With the explicit relay approach, the non-relay STA may transmit a relay request frame in a broadcast or multicast manner to request relay operations. One or more potential relay STAs that receive the relay request frame may transmit a relay response frame to the non-relay STA. The non-relay STA may select one of the one or more potential relay STAs to act as a relay between the non-relay STA and the AP. The non-relay STA may transmit a relay confirmation frame to the selected STA to confirm that the STA has been selected to act as the relay between the non-relay STA and the AP. The selected STA thus becomes a relay STA for communications between the non-relay STA and the AP. Thus, in contrast to the implicit relay approach, the non-relay STA is aware of the presence of the relay STA in the explicit approach, and may even be involved in selecting which STA is to act as the relay. The non-relay STA may transmit an association request frame for associating with the AP. The relay STA may relay the association request frame from the non-relay STA to the AP. Responsive to receiving the association request frame, the AP may transmit an association response frame. The relay STA may relay the association response frame from the AP to the non-relay STA. The exchange of the association request frame and the association response frame between the non-relay STA and the AP (via the relay STA) completes the association between the non-relay STA and the AP. The non-relay STA may then transmit a data frame that includes data intended for the AP. Responsive to receiving the data, the relay STA may transmit a first ACK frame to the non-relay STA that acknowledges that the relay STA received the data. The relay STA may relay the data (that was originated by the non-relay STA) from the non-relay STA to the AP. In an embodiment, the relay STA relays the data to the AP by transmitting a MU frame that includes the data (that was originated by the non-relay STA) and data originated by the relay STA that is intended for the AP. Responsive to receiving the MU frame, the AP may transmit a MU ACK frame to the relay STA that acknowledges that the AP received the relayed data and the data originated by the relay STA. Responsive to receiving an acknowledgement that the AP received the relayed data, the relay STA may transmit a second ACK frame to the non-relay STA that acknowledges that the AP received the data.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

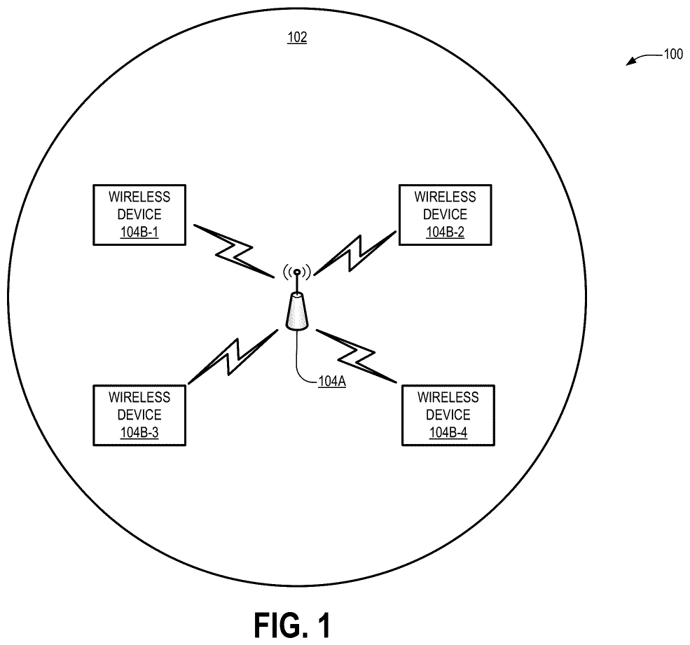

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B 1-104B₄), the WLAN 100 may include any number of non-AP STAs (e.g., one or more wireless devices 104B).

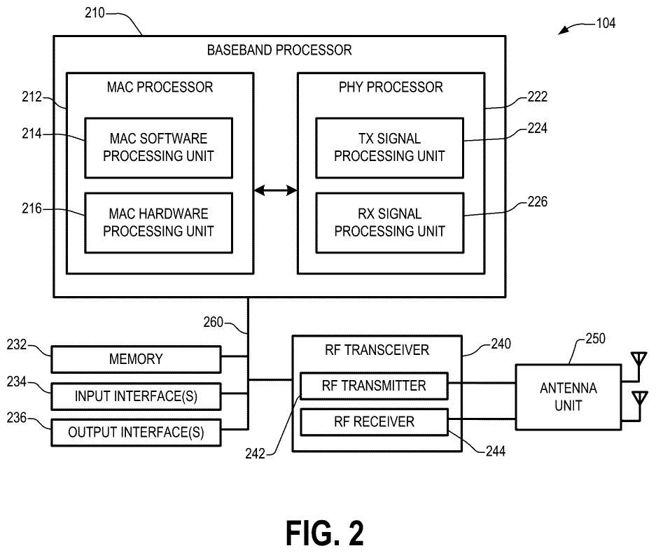

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

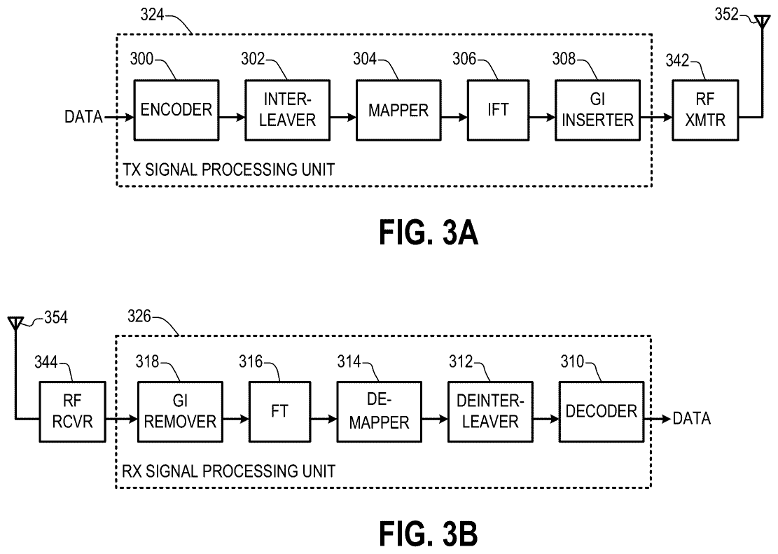

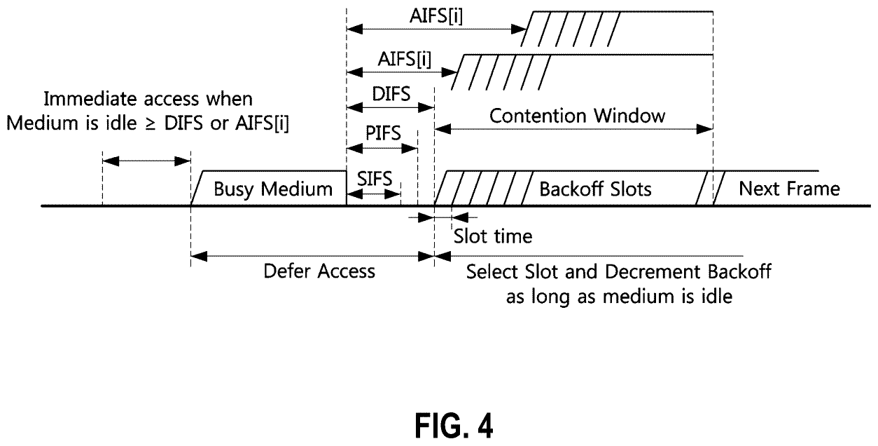

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

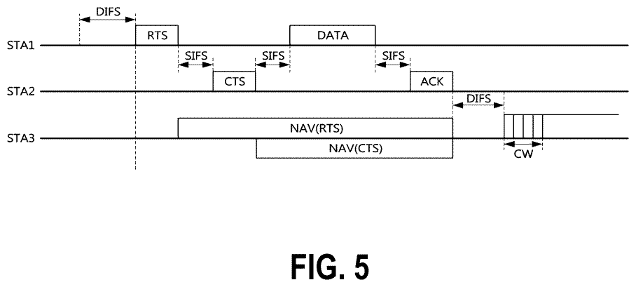

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

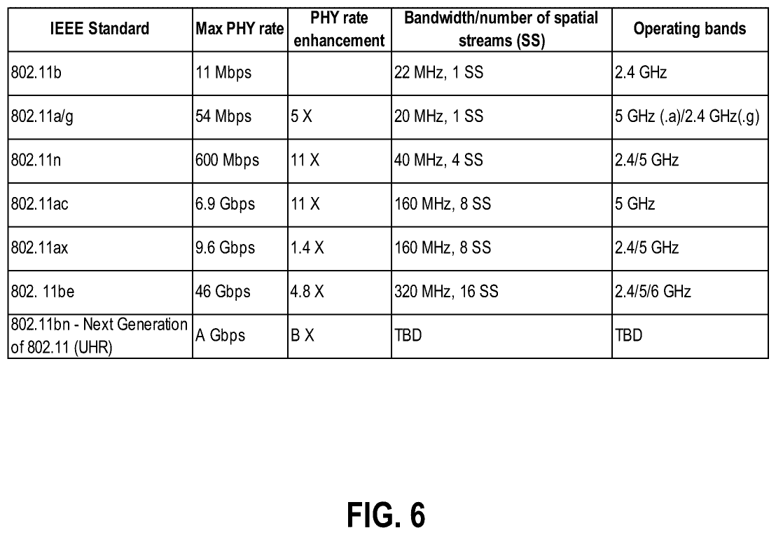

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

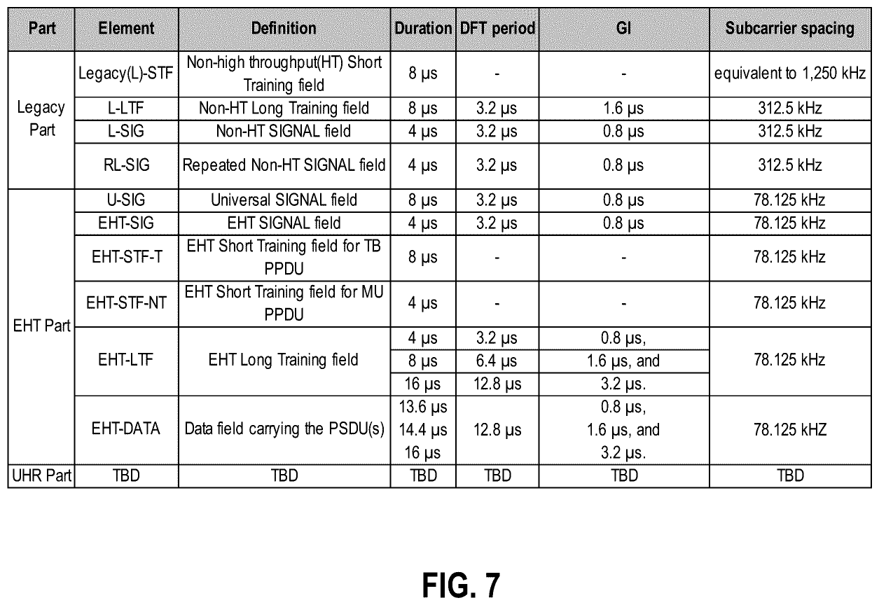

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHZ), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz or 640 MH2) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

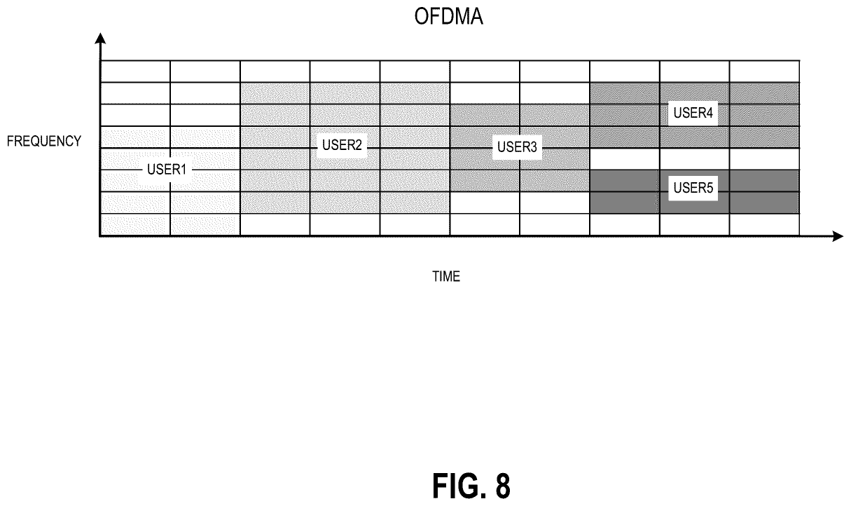

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

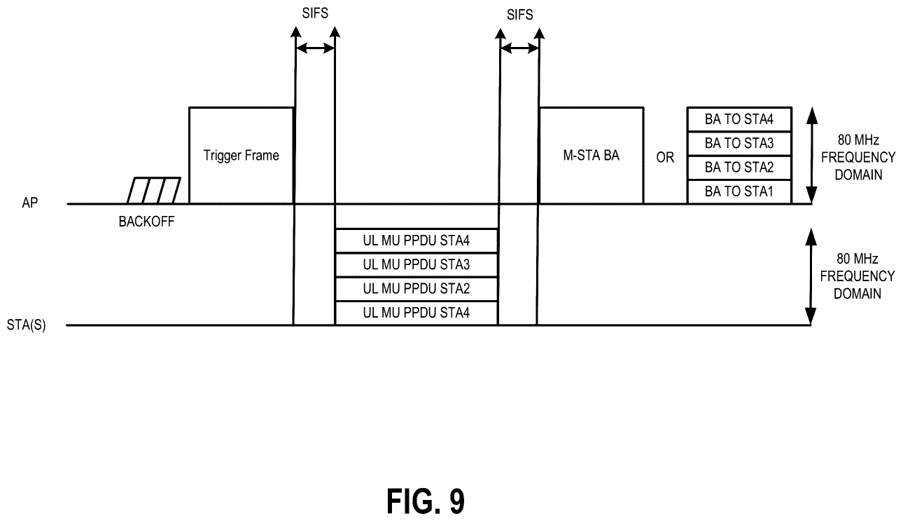

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

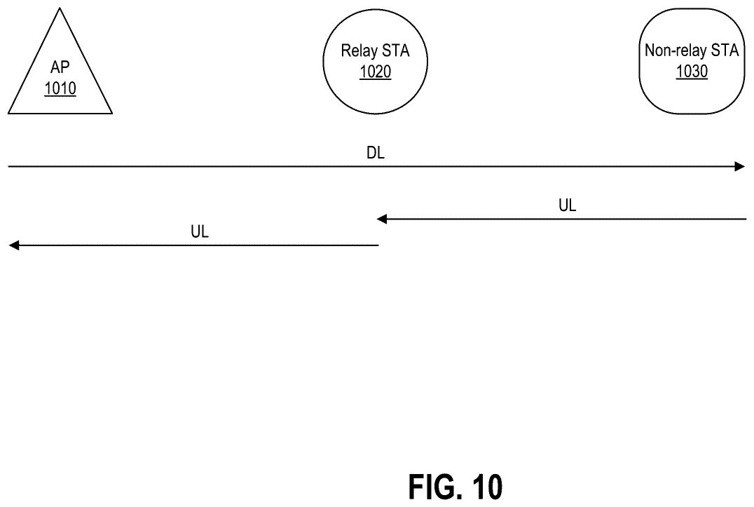

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

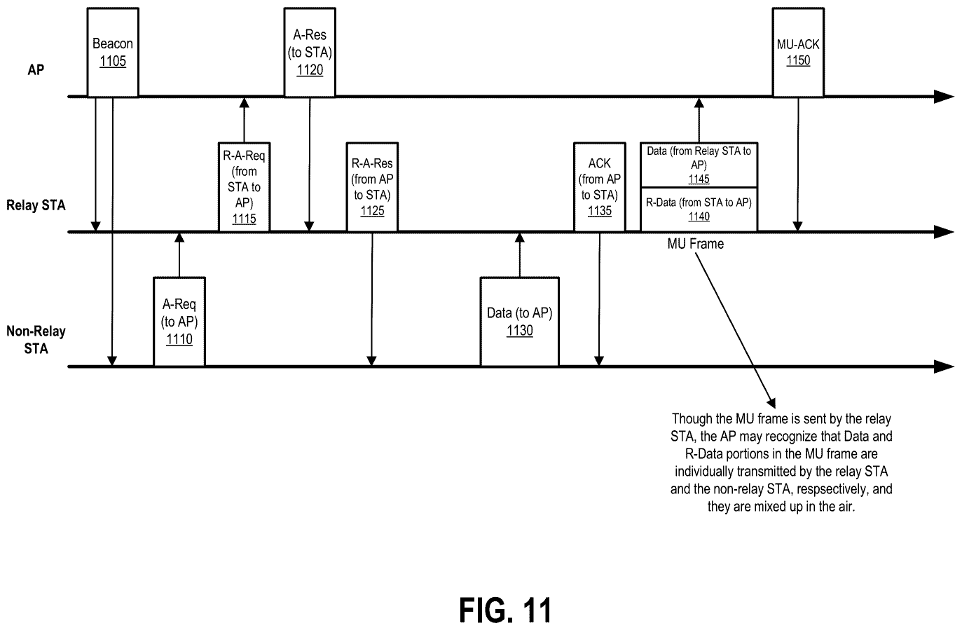

FIG. 10 is a diagram showing a network environment in which relay operations may be performed, according to some embodiments.

As shown in the diagram, the network environment includes an AP 1010, a relay STA 1020, and a non-relay STA 1030. In such a network environment, downlink control frames transmitted by the AP 1010 with low modulation coding scheme (MCS) may have relatively long communication range because the AP can transmit with high power. However, uplink frames transmitted by non-AP STAs operating on battery power may have shorter communication range compared to the downlink frames. Thus, if the AP transmits a beacon frame, the non-relay STA 1030 may be able to receive the beacon frame. Responsive to receiving the beacon frame, the non-relay STA 1030 may transmit an association request frame to the AP 1010, but the AP 1010 may not be able to receive and decode the association request frame due to short communication range. As a result, the AP 1010 cannot transmit a corresponding association response frame to the non-relay STA 130, which means that the non-relay STA 1030 cannot be associated with the AP 1010.

To address this problem, another STA that is communicatively located between the AP 1010 and the non-relay STA 1030 such as relay STA 1020 may assist with the transmission by acting as a relay between the AP 1010 and the non-relay STA 1030.

As previously mentioned, two types of relay operations are described herein: (1) an implicit relay approach and (2) an explicit relay approach. The way to determine the relay STA may be different depending on the approach. In the implicit relay approach, potential relay STAs (e.g., STAs that have the capability to act as a relay between a STA and an AP) may monitor frames transmitted by other STAs and recognize the need for relay operations. For example, if a potential relay STA detects that a STA has transmitted an association request frame for associating with an AP multiple times but the AP has not transmitted a corresponding association response frame to the STA, the potential relay STA may decide to act as a relay between the STA and the AP. To help the STA be associated with the AP, the potential relay STA may relay an association request frame from the non-relay STA to the AP. If multiple potential relay STAs try to relay the association request frame from the non-relay STA to the AP, one of the potential relay STAs that obtains the channel access opportunity can act as the relay going forward. Responsive to receiving the relayed association request frame, the AP may transmit a corresponding association response frame. The relay STA may relay this association response frame from the AP to the non-relay STA. In this way, the STA can be associated with the AP with the aid of relay operations.

In this approach, a new channel access rule for relay STAs may be introduced to allow the relay STA to act as a relay. The new channel access rule may be that if a STA decides to participate in relay operations, that STA can access the channel even during the protection period for the relay transmission. The relay STA may only be allowed to access the channel for performing relay operations, and may not be allowed to transmit its own signal (signals unrelated to relay operations) during the relay operation period (although some exceptions may apply, as will be described in additional detail herein).

In the explicit relay approach, if a STA transmits an association request frame for associating with an AP multiple times but does not receive a corresponding association response frame from the AP, the STA may transmit a relay request frame to request relay operations. The relay request frame may include the address of the AP. The relay request frame may be transmitted in a broadcast or multicast manner. Potential relay STAs (e.g., STAs that have the capability to act as a relay between the STA and the AP) that receive the relay request frame and obtain the channel access opportunity with contention may respond by transmitting a relay response frame to the STA. The non-relay STA may select one of the potential relay STAs to act as a relay between the non-relay STA and the AP and transmit a relay confirmation frame to the STA selected to be the relay STA. The non-relay STA may then transmit data to the AP with the aid of relay operations.

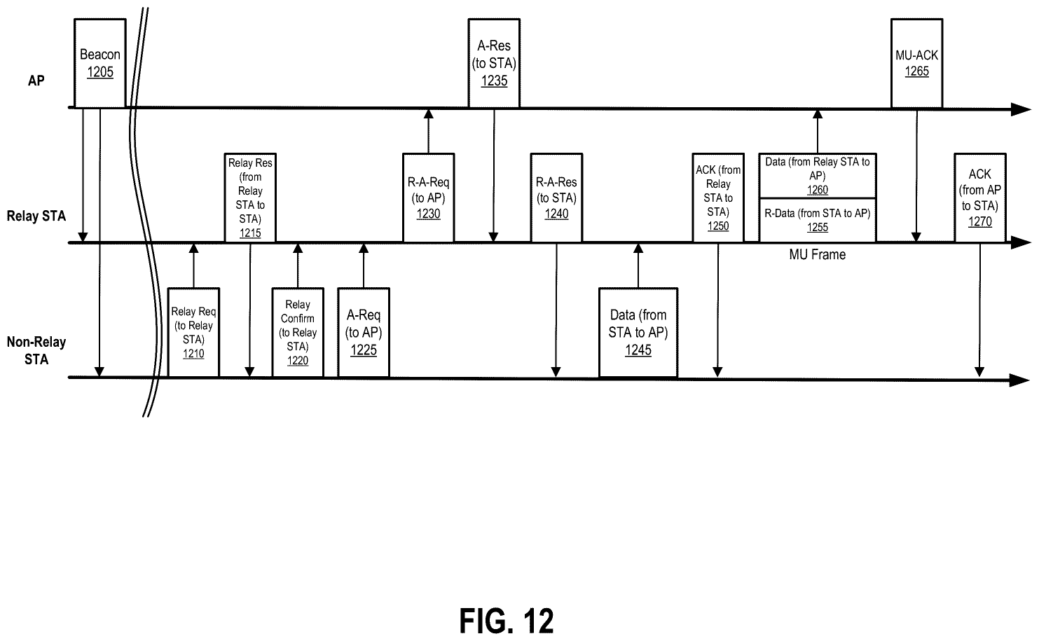

FIG. 11 is a diagram showing relay operations using an implicit relay approach, according to some embodiments. The relay operations shown in the diagram may involve an AP, a relay STA, and a non-relay STA.

As shown in the diagram, the AP may transmit a beacon frame 1105 in a broadcast manner. Responsive to receiving the beacon frame 1105, the non-relay STA may transmit an association request frame 1110 (A-Req) for associating with the AP. The relay STA may relay the association request frame 1110 from the non-relay STA to the AP by transmitting a relayed association request frame 1115 (R-A-Req) to the AP. The source address of the relayed association request frame 1115 may be set to the address of the non-relay STA and the destination address of the relayed association request frame 1115 may be set to be the address of the AP. Responsive to receiving the relayed association request frame 1115, the AP may transmit a corresponding association response frame 1120 (A-Res). The relay STA may relay the association response frame 1120 from the AP to the non-relay STA by transmitting a relayed association response frame 1125 (R-A-Res) to the non-relay STA. The source address of the relayed association response frame 1125 may be set to be the address of the AP and the destination address of the relayed association response frame 1125 may be set to be the address of the non-relay STA. At this stage, the non-relay STA is associated with the AP.

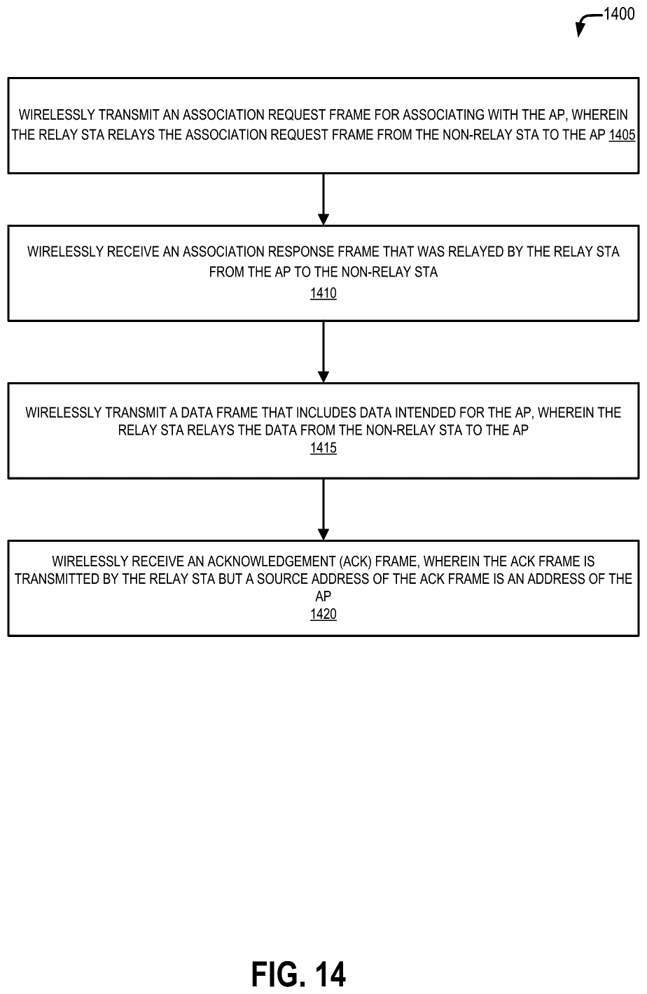

The non-relay STA may then transmit a data frame 1130 that includes data intended for the AP. The source address of the data frame 1130 may be set to the address of the non-relay STA and the destination address of the data frame 1130 may be set to the address of the AP. Responsive to receiving the data frame, the relay STA may transmit an ACK frame 1135 to the non-relay STA. Even though the relay STA transmits the ACK frame 1135, the source address of the ACK frame may be set to be the address of the AP to make it seem like the ACK frame 1135 is coming from the AP. The relay STA may transmit a MU frame that includes data 1140 originated by the non-relay STA that is being relayed (R-Data) and data 1145 originated by the relay STA that is intended for the AP. The data 1140 originated by the non-relay STA that is being relayed and the data 1145 originated by the relay STA may be multiplexed in the MU frame in the frequency domain (e.g., using OFDMA) or the spatial domain (e.g., using MU-MIMO). For example, the MU frame may be a subchannel aggregated PSDU as shown in FIG. 13 (which is an example of multiplexing in the frequency domain). As another example, some MIMO spatial streams may be used for transmitting the data 1140 being relayed and other MIMO spatial streams may be used for transmitting the data 1145 originated by the relay STA (which is an example of multiplexing in the spatial domain). The relay STA may add padding in the MU frame to align the end of the portion that includes the data 1140 that is being relayed with the end of the portion that includes the data 1145 originated by the relay STA. For example, if the portion that includes the data 1140 that is being relayed is longer than the portion that includes the data 1145 originated by the relay STA, the relay STA may add padding to the portion that includes the data 1145 originated by the relay STA to align the ends of both portions. Even though the MU frame is transmitted by the relay STA, the AP may recognize that the two portions of the MU frame are being individually transmitted by the non-relay STA and the relay STA, respectively, and are mixed up in the air. Thus, the AP may respond by transmitting a MU ACK frame that acknowledges that the AP received the relayed data 1140 and the data 1145 originated by the relay STA. In an embodiment, instead of transmitting ACK frame 1135, the relay STA transmits an ACK frame to the non-relay STA after receiving the MU ACK frame if the non-relay STA is able to understand that the ACK frame will be delayed.

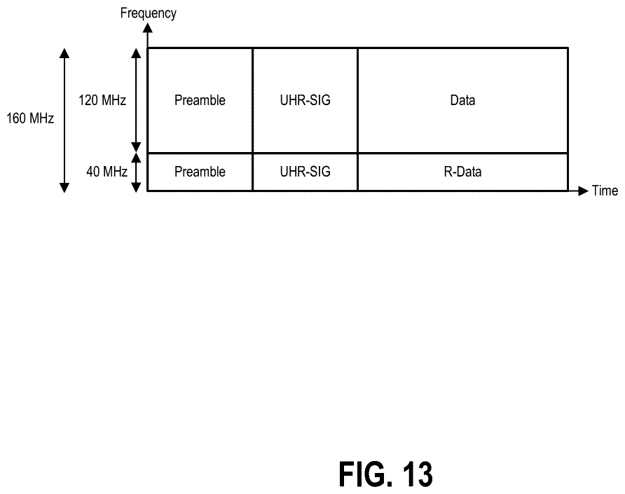

FIG. 12 is a diagram showing relay operations using an explicit relay approach, according to some embodiments.

As shown in the diagram, the AP may transmit a beacon frame 1205 in a broadcast manner. Responsive to receiving the beacon frame 1205, the non-relay STA may transmit a relay request frame 1210 (Relay Req) to the relay STA to request relay operations. Responsive to receiving the relay request frame 1210, the relay STA may transmit a relay response frame 1215 (Relay Res) to the non-relay STA to indicate that the relay STA can act as a relay. Responsive to receiving the relay response frame 1215, the non-relay STA may select the relay STA to act as a relay between the non-relay STA and the AP, and transmit a relay confirmation frame 1220 (Relay Confirm) to confirm that the relay STA has been selected to act as the relay between the non-relay STA and the AP.

The non-relay STA may then transmit an association request frame 1225 (A-Req) for associating with the AP. The source address of the association request frame 1225 may be set to be the address of the non-relay STA and the destination address of the association request frame 1225 may be set to be the address of the AP. The relay STA may relay the association request frame 1225 from the non-relay STA to the AP by transmitting a relayed association request frame 1230 (R-A-Req) to the AP. The source address of the relayed association request frame 1230 may be set to be the address of the non-relay STA and the destination address of the relayed association request frame 1225 may be set to be the address of the AP. Responsive to receiving the relayed association request frame 1230, the AP may transmit a corresponding association response frame 1235 (A-Res). The source address of the association response frame 1235 may be set to be the address of the AP and the destination address of the association response frame 1235 may be set to be the address of the non-relay STA. The relay STA may relay the association response frame 1235 from the AP to the non-relay STA by transmitting a relayed association response frame 1240 (R-A-Res) to the non-relay STA. The source address of the relayed association response frame 1240 may be set to be the address of the AP and the destination address of the relayed association response frame 1240 may be set to be the address of the non-relay STA. In an embodiment, the relay confirmation frame 1220 can be omitted because the association request frame 1225 may serve as the confirmation. At this stage, the non-relay STA is associated with the AP.

The non-relay STA may then transmit a data frame 1245 that includes data intended for the AP. The data frame 1245 may include an indication that the data included therein is intended for the AP (e.g., the destination address of the data frame 1245 may be set to be the address of the AP). Responsive to receiving the data frame 1245, the relay STA may transmit a first ACK frame 1250 that acknowledges that the relay STA received the data. The source address of the first ACK frame 1250 may be set to be the address of the relay STA and the destination address of the first ACK frame 1250 may be set to be the address of the non-relay STA. The relay STA may transmit a MU frame that includes data 1255 originated by the non-relay STA that is being relayed (R-Data) and data 1260 originated by the relay STA that is intended for the AP, if the relay STA has its own data to transmit to the AP. Otherwise, if the relay STA does not have its own data to transmit to the AP, the relay STA may transmit a single-user (SU) frame that only includes the data 1255 being relayed. Responsive to receiving the MU frame (or SU frame), the AP may transmit a MU ACK frame 1265 (or regular ACK frame) that acknowledges that the AP received the relayed data 1140 and the data 1145 originated by the relay STA (or just the data 1145 originated by the relay STA). Responsive to receiving an acknowledgement that the AP received the relayed data (via the MU ACK frame 1265 or a regular ACK frame), the relay STA may transmit a second ACK frame 1270 to the non-relay STA that acknowledges that the AP received the data. The source address of the second ACK frame 1270 may be set to be the address of the AP and the destination address of the second ACK frame 1270 may be set to be the address of the non-relay STA. In an embodiment, if the AP can transmit the MU ACK frame 1265 using sufficiently high transmit power such that the MU ACK frame 1265 can reach the non-relay STA, the second ACK frame 1270 can be omitted. Since the second ACK frame 1270 (which indicates successful data reception at the AP) is fed back with a longer delay compared to a normal ACK operation, in an embodiment, the first ACK frame 1250 may include an indication that the second ACK frame 1270 will be delayed (e.g., the second ACK frame 1270 might not arrive within the ACK timeout) to allow the non-relay STA to expect a delayed acknowledgement. Even without such an explicit delayed ACK indication, a delayed ACK policy can be implicitly activated when relay operations are being performed.

FIG. 13 is a diagram showing a MU frame format that can include relayed data and data originated by the relay STA, according to some embodiments.

The MU frame shown in the diagram may be transmitted by a relay STA (e.g., to transmit relayed data and its own data), as described above. In the diagram, the x-axis represents time and the y-axis represents frequency. As shown in the diagram, the MU frame occupies a 160 MHz bandwidth. The MU frame includes a first portion that occupies a 40 MHZ subchannel and a second portion that occupies a 160 MHz subchannel. Each portion includes a preamble and a UHR-SIG field. The first portion may include the relayed data (R-Data) and the second portion may include data originated by the relay STA (Data).

In an embodiment, the MU frame (e.g., that includes the data being relayed and the data originated by the relay STA) may be transmitted using an interframe space (IFS) interval that is shorter compared to a DIFS interval used in the wireless network to give priority to a frame with data being relayed. This priority can be regarded as a benefit for the relay STA to support relay operations.

In this disclosure, we provided two typical examples, the combination of the proposed approaches can be considered as an extension of the proposed relay mechanism. For example, the delay ACK indication and second ACK frame described for the explicit relay approach (e.g., shown in FIG. 12) can be included in the implicit relay approach (e.g., shown in FIG. 11).

The relay operations described herein can be used to provide longer communication range and higher throughput in a wireless network. The relay operations described herein can be realized on top of an IEEE 802.11 type wireless network.

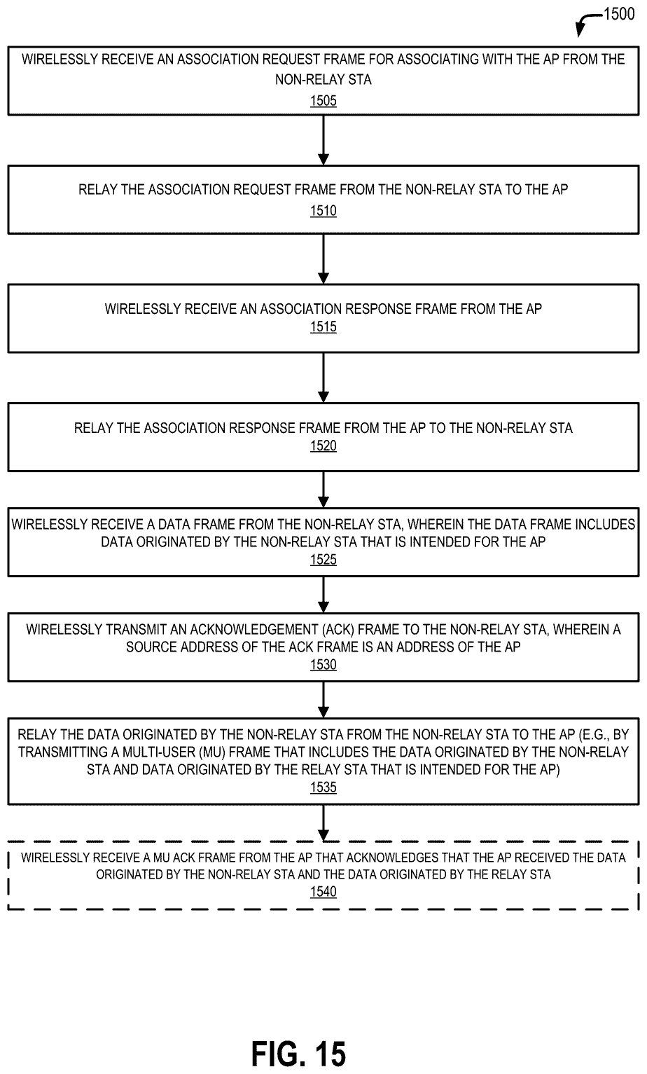

Turning now to FIG. 14, a method 1400 will be described for communicating with an AP with the aid of relay operations (in an implicit relay approach), in accordance with an example embodiment. The method 1400 may be performed by a non-relay STA. The non-relay STA may be implemented by one or more devices described herein such as wireless device 104.

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

At operation 1405, the non-relay STA wirelessly transmits an association request frame for associating with the AP, wherein the relay STA relays the association request frame from the non-relay STA to the AP. In an embodiment, the relay STA relays the association request frame from the non-relay STA to the AP responsive to detecting that the non-relay STA transmitted a plurality of association request frames for associating with the AP to the AP without the AP transmitting a corresponding association response frame to the non-relay STA.

At operation 1410, the non-relay STA wirelessly receives an association response frame that was relayed by the relay STA from the AP to the non-relay STA.

At operation 1415, the non-relay STA wirelessly transmits a data frame that includes data intended for the AP, wherein the relay STA relays the data from the non-relay STA to the AP.

At operation 1420, the non-relay STA wirelessly receives an ACK frame, wherein the ACK frame is transmitted by the relay STA but a source address of the ACK frame is an address of the AP.

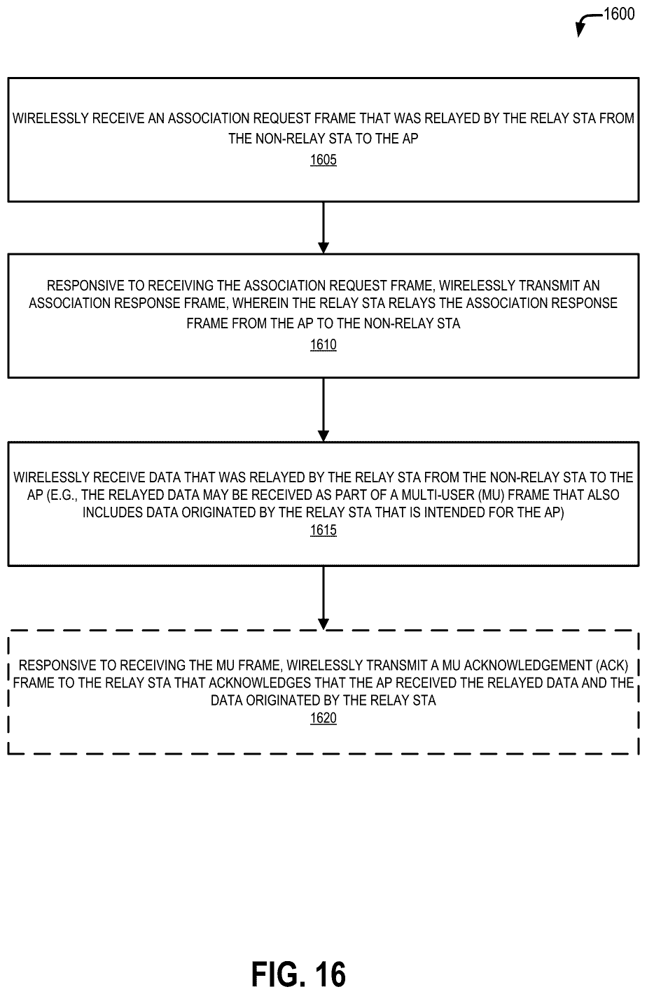

Turning now to FIG. 15, a method 1500 will be described for performing relay operations (in an implicit relay approach), in accordance with an example embodiment. The method 1500 may be performed by a relay STA. The relay STA may be implemented by one or more devices described herein such as wireless device 104.

At operation 1505, the relay STA wirelessly receives an association request frame for associating with the AP from the non-relay STA.

At operation 1510, the relay STA relays the association request frame from the non-relay STA to the AP. In an embodiment, the association request frame is relayed from the non-relay STA to the AP responsive to detecting that the non-relay STA transmitted a plurality of association request frames for associating with the AP to the AP without the AP transmitting a corresponding association response frame to the non-relay STA.

At operation 1515, the relay STA wirelessly receives an association response frame from the AP.

At operation 1520, the relay STA relays the association response frame from the AP to the non-relay STA.

At operation 1525, the relay STA wirelessly receives a data frame from the non-relay STA, wherein the data frame includes data originated by the non-relay STA that is intended for the AP.

At operation 1530, the relay STA wirelessly transmits an ACK frame to the non-relay STA, wherein a source address of the ACK frame is an address of the AP.

At operation 1535, the relay STA relays the data originated by the non-relay STA from the non-relay STA to the AP. In an embodiment, the data originated by the non-relay STA is relayed by transmitting a MU frame that includes the data originated by the non-relay STA and data originated by the relay STA that is intended for the AP. In an embodiment, the data originated by the non-relay STA and the data originated by the relay STA are multiplexed in the MU frame in a frequency domain. In an embodiment, the MU frame includes padding to align an end of a portion that includes the data originated by the non-relay STA with an end of a portion that includes the data originated by the relay STA. In an embodiment, the MU frame is transmitted using an IFS interval that is shorter compared to a DIFS interval used in the wireless network.

In an embodiment, at operation 1540, the relay STA wirelessly receives a MU ACK frame from the AP that acknowledges that the AP received the data originated by the non-relay STA and the data originated by the relay STA.

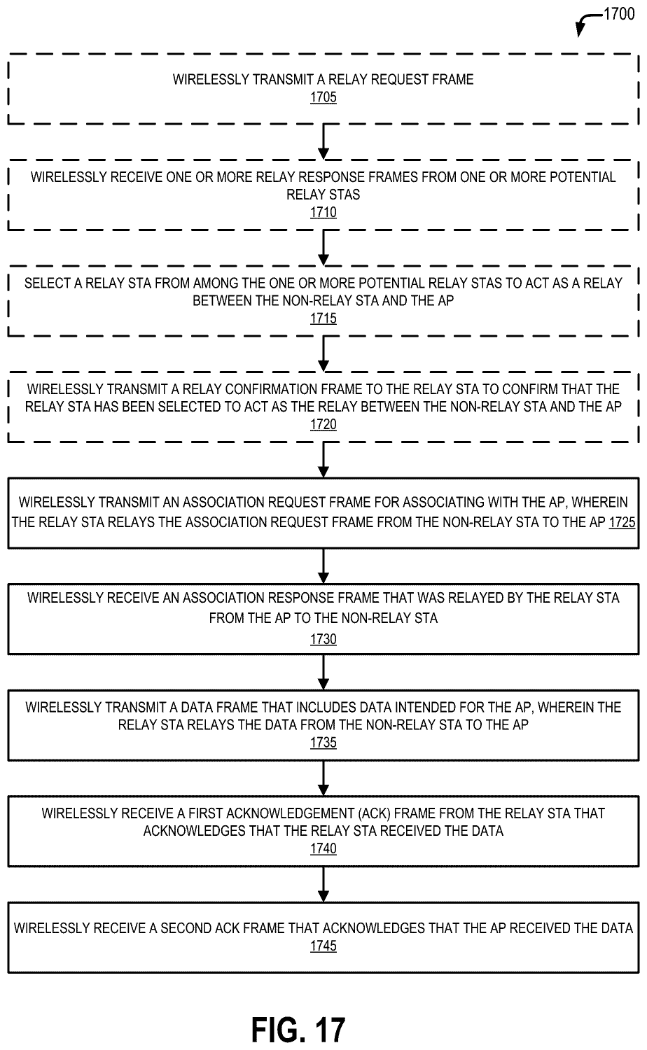

Turning now to FIG. 16, a method 1600 will be described for communicating with a non-relay STA with the aid of relay operations, in accordance with an example embodiment. The method 1600 may be performed by an AP. The AP may be implemented by one or more devices described herein such as wireless device 104.

At operation 1605, the AP wirelessly receives an association request frame that was relayed by the relay STA from the non-relay STA to the AP.

At operation 1610, responsive to receiving the association request frame, the AP wirelessly transmits an association response frame, wherein the relay STA relays the association response frame from the AP to the non-relay STA.

At operation 1615, the AP wirelessly receives data that was relayed by the relay STA from the non-relay STA to the AP. In an embodiment, the relayed data is received as part of a MU frame that also includes data originated by the relay STA that is intended for the AP.

In an embodiment, at operation 1620, responsive to receiving the MU frame, the AP wirelessly transmits a MU ACK frame to the relay STA that acknowledges that the AP received the relayed data and the data originated by the relay STA.

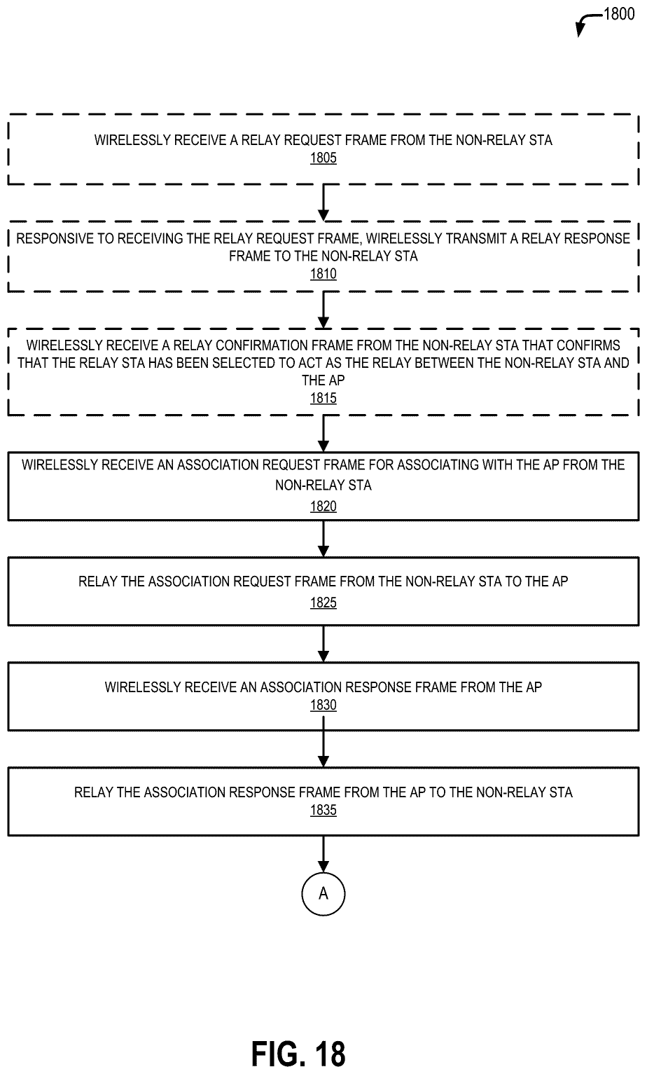

Turning now to FIG. 17, a method 1700 will be described for communicating with an AP with the aid of relay operations (in an explicit relay approach), in accordance with an example embodiment. The method 1700 may be performed by a non-relay STA. The non-relay STA may be implemented by one or more devices described herein such as wireless device 104.

In an embodiment, at operation 1705, the non-relay STA wirelessly transmits a relay request frame. In an embodiment, the relay request frame is transmitted responsive to transmitting a plurality of association request frames for associating with the AP to the AP without receiving a corresponding association response frame from the AP. In an embodiment, the relay request frame is transmitted in a broadcast or multicast manner.

In an embodiment, at operation 1710, the non-relay STA wirelessly receives one or more relay response frames from one or more potential relay STAs.

In an embodiment, at operation 1715, the non-relay STA selects a relay STA from among the one or more potential relay STAs to act as a relay between the non-relay STA and the AP.

In an embodiment, at operation 1720, the non-relay STA wirelessly transmits a relay confirmation frame to the relay STA to confirm that the relay STA has been selected to act as the relay between the non-relay STA and the AP.

At operation 1725, the non-relay STA wirelessly transmits an association request frame for associating with the AP, wherein the relay STA relays the association request frame from the non-relay STA to the AP.

At operation 1730, the non-relay STA wirelessly receives an association response frame that was relayed by the relay STA from the AP to the non-relay STA.

At operation 1735, the non-relay STA wirelessly transmits a data frame that includes data intended for the AP, wherein the relay STA relays the data from the non-relay STA to the AP.

At operation 1740, the non-relay STA wirelessly receives a first ACK frame from the relay STA that acknowledges that the relay STA received the data.

At operation 1745, the non-relay STA wirelessly receives a second ACK frame that acknowledges that the AP received the data. In an embodiment, the relay STA transmits the second ACK frame to the non-relay STA responsive to receiving a third ACK frame from the AP that acknowledges that the AP received the data. In an embodiment, the AP transmits the second ACK frame to the non-relay STA, wherein the second ACK frame is a MU ACK frame that also acknowledges data originated by the relay STA that was transmitted by the relay STA to the AP. In an embodiment, the first ACK frame includes an indication that the second ACK frame will be delayed.

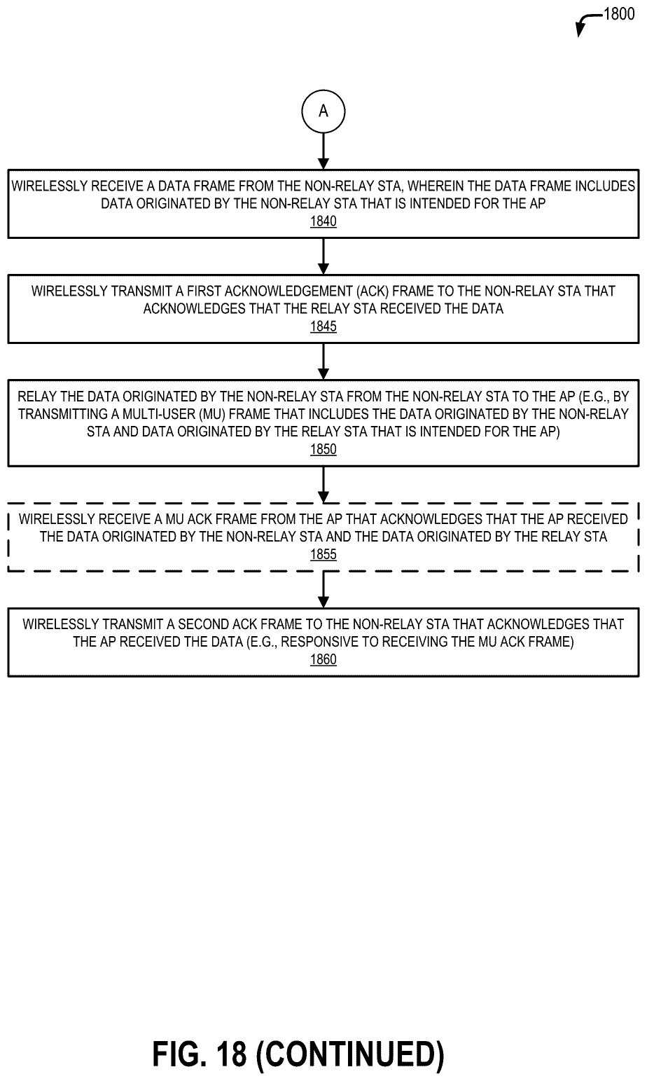

Turning now to FIG. 18, a method 1800 will be described for performing relay operations (in an explicit relay approach), in accordance with an example embodiment. The method 1800 may be performed by a relay STA. The relay STA may be implemented by one or more devices described herein such as wireless device 104.

In an embodiment, at operation 1805, the relay STA wirelessly receives a relay request frame from the non-relay STA (to request relay operations).

In an embodiment, at operation 1810, responsive to receiving the relay request frame, the relay STA wirelessly transmits a relay response frame to the non-relay STA (to indicate that the relay STA can act as a relay).

In an embodiment, at operation 1815, the relay STA wirelessly receives a relay confirmation frame from the non-relay STA that confirms that the relay STA has been selected to act as a relay between the non-relay STA and the AP.

At operation 1820, the relay STA wirelessly receives an association request frame for associating with the AP from the non-relay STA.

At operation 1825, the relay STA relays the association request frame from the non-relay STA to the AP.

At operation 1830, the relay STA wirelessly receives an association response frame from the AP.

At operation 1835, the relay STA relays the association response frame from the AP to the non-relay STA.

At operation 1840, the relay STA wirelessly receives a data frame from the non-relay STA, wherein the data frame includes data originated by the non-relay STA that is intended for the AP.

At operation 1845, the relay STA wirelessly transmits a first ACK frame to the non-relay STA that acknowledges that the relay STA received the data.

At operation 1850, the relay STA relays the data originated by the non-relay STA from the non-relay STA to the AP. In an embodiment, the data originated by the non-relay STA is relayed by transmitting a MU frame that includes the data originated by the non-relay STA and data originated by the relay STA that is intended for the AP. In an embodiment, the data originated by the non-relay STA and the data originated by the relay STA are multiplexed in the MU frame in a frequency domain. In an embodiment, the MU frame includes padding to align an end of a portion that includes the data originated by the non-relay STA with an end of a portion that includes the data originated by the relay STA. In an embodiment, the MU frame is transmitted using an IFS interval that is shorter compared to a DIFS interval used in the wireless network.

In an embodiment, at operation 1855, the relay STA wirelessly receives a MU ACK frame from the AP that acknowledges that the AP received the data originated by non-relay STA and the data originated by the relay STA.

At operation 1860, the relay STA wirelessly transmits a second ACK frame to the non-relay STA that acknowledges that the AP received the data. In an embodiment, the second ACK frame is transmitted responsive to receiving the MU ACK frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a non-relay station (STA) implemented by a wireless device to communicate with an access point (AP) via a relay STA, the method comprising:
wirelessly transmitting an association request frame for associating with the AP, wherein the relay STA relays the association request frame from the non-relay STA to the AP;
wirelessly receiving an association response frame that was relayed by the relay STA from the AP to the non-relay STA;
wirelessly transmitting a data frame that includes data intended for the AP, wherein the relay STA relays the data from the non-relay STA to the AP; and
wirelessly receiving an acknowledgement (ACK) frame, wherein the ACK frame is transmitted by the relay STA but a source address of the ACK frame is an address of the AP.

2. The method of claim 1, wherein the relay STA relays the association request frame from the non-relay STA to the AP responsive to detecting that the non-relay STA transmitted a plurality of association request frames for associating with the AP to the AP without the AP transmitting a corresponding association response frame to the non-relay STA.

3. A method performed by a relay station (STA) implemented by a wireless device to act as a relay between a non-relay STA and an access point (AP), the method comprising:
wirelessly receiving an association request frame for associating with the AP from the non-relay STA;
relaying the association request frame from the non-relay STA to the AP;
wirelessly receiving an association response frame from the AP;
relaying the association response frame from the AP to the non-relay STA;
wirelessly receiving a data frame from the non-relay STA, wherein the data frame includes data originated by the non-relay STA that is intended for the AP;
wirelessly transmitting an acknowledgement (ACK) frame to the non-relay STA, wherein a source address of the ACK frame is an address of the AP; and
relaying the data originated by the non-relay STA from the non-relay STA to the AP.

4. The method of claim 3, wherein the data originated by the non-relay STA is relayed by transmitting a multi-user (MU) frame that includes the data originated by the non-relay STA and data originated by the relay STA that is intended for the AP.

5. The method of claim 4, wherein the data originated by the non-relay STA and the data originated by the relay STA are multiplexed in the MU frame in a frequency domain.

6. The method of claim 5, wherein the MU frame includes padding to align an end of a portion that includes the data originated by the non-relay STA with an end of a portion that includes the data originated by the relay STA.

7. The method of claim 4, wherein the MU frame is transmitted using an interframe space (IFS) interval that is shorter compared to a distributed coordination function IFS (DIFS) interval.

8. The method of claim 4, further comprising:
wirelessly receiving a MU ACK frame from the AP that acknowledges that the AP received the data originated by the non-relay STA and the data originated by the relay STA.

9. The method of claim 3, wherein the association request frame is relayed from the non-relay STA to the AP responsive to detecting that the non-relay STA transmitted a plurality of association request frames for associating with the AP to the AP without the AP transmitting a corresponding association response frame to the non-relay STA.

10. A method performed by an access point (AP) implemented by a wireless device to communicate with a non-relay station (STA) via a relay STA, the method comprising:
wirelessly receiving an association request frame that was relayed by the relay STA from the non-relay STA to the AP;
responsive to receiving the association request frame, wirelessly transmitting an association response frame, wherein the relay STA relays the association response frame from the AP to the non-relay STA; and
wirelessly receiving data that was relayed by the relay STA from the non-relay STA to the AP.

11. The method of claim 10, wherein the relayed data is received as part of a multi-user (MU) frame that also includes data originated by the relay STA that is intended for the AP.

12. The method of claim 11, further comprising:
responsive to receiving the MU frame, wirelessly transmitting a MU acknowledgement (ACK) frame to the relay STA that acknowledges that the AP received the relayed data and the data originated by the relay STA.

13. A method performed by a non-relay station (STA) implemented by a wireless device to communicate with an access point (AP) via a relay STA, the method comprising:
wirelessly transmitting an association request frame for associating with the AP, wherein the relay STA relays the association request frame from the non-relay STA to the AP;
wirelessly receiving an association response frame that was relayed by the relay STA from the AP to the non-relay STA;
wirelessly transmitting a data frame that includes data intended for the AP, wherein the relay STA relays the data from the non-relay STA to the AP;
wirelessly receiving a first acknowledgement (ACK) frame from the relay STA that acknowledges that the relay STA received the data; and
wirelessly receiving a second ACK frame that acknowledges that the AP received the data.

14. The method of claim 13, further comprising:
wirelessly transmitting a relay request frame;
wirelessly receiving one or more relay response frames from one or more potential relay STAs including the relay STA; and
selecting the relay STA from among the one or more potential relay STAs to act as a relay between the non-relay STA and the AP.

15. The method of claim 14, further comprising:
wirelessly transmitting a relay confirmation frame to the relay STA to confirm that the relay STA has been selected to act as the relay between the non-relay STA and the AP.

16. The method of claim 14, wherein the relay request frame is transmitted responsive to transmitting a plurality of association request frames for associating with the AP to the AP without receiving a corresponding association response frame from the AP.

17. The method of claim 14, wherein the relay request frame is transmitted in a broadcast or multicast manner.

18. The method of claim 13, wherein the relay STA transmits the second ACK frame to the non-relay STA responsive to receiving a third acknowledgement (ACK) frame from the AP that acknowledges that the AP received the data.

19. The method of claim 13, wherein the AP transmits the second ACK frame to the non-relay STA, wherein the second ACK frame is a multi-user (MU) ACK frame that also acknowledges data originated by the relay STA that was transmitted by the relay STA to the AP.

20. The method of claim 13, wherein the first ACK frame includes an indication that the second ACK frame will be delayed.

21. A method performed by a relay station (STA) implemented by a wireless device to act as a relay between a non-relay STA and an access point (AP), the method comprising:
wirelessly receiving an association request frame for associating with the AP from the non-relay STA;
relaying the association request frame from the non-relay STA to the AP;
wirelessly receiving an association response frame from the AP;
relaying the association response frame from the AP to the non-relay STA;
wirelessly receiving a data frame from the non-relay STA, wherein the data frame includes data originated by the non-relay STA that is intended for the AP;
wirelessly transmitting a first acknowledgement (ACK) frame to the non-relay STA that acknowledges that the relay STA received the data;
relaying the data originated by the non-relay STA from the non-relay STA to the AP; and
wirelessly transmitting a second ACK frame to the non-relay STA that acknowledges that the AP received the data.

22. The method of claim 21, further comprising:
wirelessly receiving a relay request frame from the non-relay STA; and
responsive to receiving the relay request frame, wirelessly transmitting a relay response frame to the non-relay STA.

23. The method of claim 22, further comprising:
wirelessly receiving a relay confirmation frame from the non-relay STA that confirms that the relay STA has been selected to act as the relay between the non-relay STA and the AP.

24. The method of claim 21, wherein the data originated by the non-relay STA is relayed by transmitting a multi-user (MU) frame that includes the data originated by the non-relay STA and data originated by the relay STA that is intended for the AP.

25. The method of claim 24, wherein the data originated by the non-relay STA and the data originated by the relay STA are multiplexed in the MU frame in a frequency domain.

26. The method of claim 25, wherein the MU frame includes padding to align an end of a portion that includes the data originated by the non-relay STA with an end of a portion that includes the data originated by the relay STA.

27. The method of claim 24, wherein the MU frame is transmitted using an interframe space (IFS) interval that is shorter compared to a distributed coordination function IFS (DIFS) interval.

28. The method of claim 24, further comprising:
wirelessly receiving a MU ACK frame from the AP that acknowledges that the AP received the data originated by the non-relay STA and the data originated by the relay STA, wherein the second ACK frame is transmitted to the non-relay STA responsive to receiving the MU ACK frame from the AP.

29. The method of claim 21, wherein the first ACK frame includes an indication that the second ACK frame will be delayed.
